(19) United States
(12) Patent Application Publication
(10) Pub. No.: US 2026/0321454 A1
(43) Pub. Date: Oct. 15, 2026

(54) POWER CABLE HAVING A THERMOPLASTIC ELECTRICALLY INSULATING LAYER

(71) Applicant: PRYSMIAN S.p.A., MILANO (IT)

(72) Inventors: Lidia TERRUZZI, Milano (IT); Gaetano GUERRA, Fisciano (SA) (IT); Elio MOROTTI, Milano (IT); Baku NAGENDRA, Fisciano (SA) (IT)

(73) Assignee: PRYSMIAN S.p.A., MILANO (IT)

(21) Appl. No.: 19/462,053

(22) Filed: Jan. 28, 2026

(30) Foreign Application Priority Data
Jan. 30, 2025 (IT) 102025000001689

(51) Int. Cl. H01B 3/44; C08F 210/16; H01B 9/02

(52) U.S. Cl. CPC H01B 3/441; C08F 210/16; H01B 9/027; C08F 2800/10

(57) ABSTRACT

A power cable comprising at least one electrical conductor and an electrically insulating system comprising: an inner semiconducting layer surrounding the electrical conductor, an electrically insulating layer surrounding the inner semiconducting layer, an outer semiconducting layer surrounding the electrically insulating layer. At least the electrically insulating layer is made of a thermoplastic polymer material comprising at least one copolymer of ethylene with at least one C₄-C₈ alpha-olefin comonomer, wherein: the at least one C₄-C₈ alpha-olefin comonomer is present in the copolymer in an amount of from 1 to 10 mol %, for example from 1.5 to 5 mol %; the copolymer has a density of from 0.880 g/cc to 0.930 g/cc, for example from 0.900 g/cc to 0.925 g/cc; the copolymer has a melting profile, determined by Differential Scanning calorimetry (DSC), which includes a melting peak, corresponding to the maximum melting temperature of the melting profile, which defines a melting enthalpy up to 50% of the overall melting enthalpy. Such thermoplastic polymer material, which is recyclable, has improved thermal conductivity as well as good mechanical and electrical performance.

### FIELD OF THE DISCLOSURE

The present disclosure relates to a power cable, for example to a medium voltage or high voltage power cable, having a thermoplastic electrically insulating layer with improved thermal conductivity. The thermoplastic electrically insulating layer is made from a polymer material which is non-crosslinked, thus it may be recycled.

### BACKGROUND ART

Cables for transporting or distributing electrical energy (in the following also referred to as “power cables”), for example for medium or high voltage applications, include a cable core usually comprising an electric conductor coated with an insulating system, sequentially formed by an inner polymeric layer having electrically semiconducting properties, an intermediate polymeric layer having electrically insulating properties, an outer polymeric layer having electrically semiconducting properties.

Medium and or high voltage power cables generally include a screen layer surrounding the cable core, typically made of metal or of metal and polymeric material. The screen layer can be made in form of wires (braids), of a tape helically wound around the cable core or a sheet longitudinally wrapped around the cable core.

Products of environmental compatibility made of materials that, in addition to not being harmful to the environment during production or utilization, may be easily recycled at the end of their life are nowadays requested in the field of electrical and telecommunications cables. However, the use of materials compatible with the environment is conditioned by the need to limit costs while providing a performance equal to or better than that of conventional materials.

In the case of medium and high voltage power cables, the layers of the insulating system surrounding the conductor are commonly made from a polyolefin-based crosslinked polymer material, in particular crosslinked polyethylene (XLPE), or elastomeric ethylene/propylene (EPR) or ethylene/propylene/diene (EPDM) copolymers, also crosslinked. The crosslinking, carried out after the step of extrusion of the polymeric material onto the conductor, gives the material satisfactory mechanical and electrical properties both during continuous use and with current overload.

It is well known, however, that crosslinked materials cannot be recycled, so that manufacturing wastes and the covering material of cables which have reached the end of their life may be disposed of only by incineration or grinding.

Furthermore, the crosslinking process is carried out in complex and expensive plants, having per se a low productivity, which is further limited by the necessity of extracting from the so produced cables the crosslinking by-products by means of a long-lasting degassing process.

In view of these drawbacks, therefore, cables with electrically insulating layers made from non-crosslinked polymer materials that can operate at suitably high temperatures are desired.

Power cables with an electrically insulating layer made of thermoplastic materials are known, wherein the thermoplastic materials are based on propylene homopolymers and/or copolymers. See for instance WO 2004/066318 and WO 02/03398. These propylene-based thermoplastic materials generally comprise a heterophasic copolymer comprising a thermoplastic phase based on propylene and an elastomeric phase based on ethylene copolymerized with an alpha-olefin.

However, the thermal conductivity of polypropylene is quite low (about 0.20 W/mK). Thus, polypropylene can generate a thermal resistance which limits the current rating of the conductor to a significant extent. In addition, when cables, especially high voltage direct current cables, are under tension, once the electrical stress is above a threshold value, resistive currents may pass through the insulation layer generating heat, which is poorly dissipated by the polypropylene insulating material just because of its low thermal conductivity. Moreover, the heat generated in the conductor and poorly dissipated by a low thermally conductive insulating material may decrease the insulating material resistivity, causing electrical leaks through the insulation and incurring thermal instability.

Polyethylene has a more favourable thermal conductivity (around 0.40 W/mK), however it must be crosslinked to achieve suitable mechanical properties at the cable operating temperatures, particularly as regards mechanical strength. Because of crosslinking, polyethylene loses its thermoplastic properties, and thus it becomes not recyclable.

U.S. Pat. No. 11,205,526 B2 relates to linear low-density polyethylene polymers (LLDPE) used to form covering layers for cables. Such polymers exhibit a Mz/Mn molecular weight distribution of about 20 to about 40 and a melt index of 0.8 to about 2. The polymer can be crosslinked to exhibit suitable properties including: a retained elongation at break values, after heat aging at 121° C. for 7 days, greater than 76% of the unaged elongation at break percentage; and a hot set value of about 10% or less.

WO 2011/113685 A1 relates to the use of a polymer composition for producing a layer, preferably an insulation layer, of a direct current (DC) power cable. Said composition comprises: (a) a polyolefin provided that, when the polyolefin is a low-density polyethylene (LDPE), then it is non-crosslinked; and optionally (b) a second polyolefin which is different from the polyolefin (a). In one preferable embodiment, the polyolefin (a) is a low-pressure PE selected from a very low-density ethylene copolymer (VLDPE), a linear low density ethylene copolymer (LLDPE), a medium density ethylene copolymer (MDPE) or a high-density ethylene homopolymer or copolymer (HDPE). In particular, the LLDPE has a density of from 909 to 930 kg/m³, preferably of from 910 to 929 kg/m³, more preferably of from 915 to 929 kg/m³.

### SUMMARY OF THE DISCLOSURE

In view of the above-illustrated state of the art, the Applicant has faced the problem of providing a power cable in which at least the insulating layer of the insulating system is made from a thermoplastic polymer material, which is recyclable, having improved thermal conductivity as well as good mechanical and electrical performance. In particular, the cable should exhibit acceptable electrical and mechanical performance at relatively high operating temperatures, e.g. higher than 70° C. and up to at least 110° C., for example up to 90° C.

The Applicant has now found that the above goal is achieved by a power cable in which the electrically insulating system comprises a thermoplastic polymer material, wherein the thermoplastic polymer material comprises a copolymer of ethylene with at least one C₄-C₈ alpha-olefin comonomer, wherein the at least one comonomer is present in an amount of from 1 to 10 mol %, for example from 1.5 to 5 mol %, and the copolymer has a density of from 0.880 g/cc to 0.930 g/cc, for example from 0.900 g/cc to 0.925 g/cc. Moreover, the copolymer has a melting profile, determined by Differential Scanning calorimetry (DSC), which includes a melting peak, corresponding to the maximum melting temperature of the melting profile, which defines a melting enthalpy equal to or lower than 50% of the overall melting enthalpy (hereinafter also referred to as melting ratio).

The melting ratio of the present copolymer is calculated by deconvolution of DSC 2^{nd} heating scan of the copolymer according to, e.g., “Deconvolution of Thermal Analysis Data using Commonly Cited Mathematical Models”, TA431, TA Instruments (https://www.tainstruments.com/pdf/literature/TA431.pdf, uploaded on Apr. 23, 2020). In particular, the highest temperature deconvoluted Tₘ peak is denoted as T_{mH}, and the corresponding melting enthalpy is denoted as ΔH_{mH}. The melting ratio is calculated as (ΔH_{mH}/ΔHₘ)*100, where ΔHₘ is the overall melting enthalpy of the copolymer. This value is related to the broadness of the melting peak.

According to a first aspect, the present disclosure relates to a power cable comprising at least one electrical conductor and an electrically insulating system comprising:
an inner semiconducting layer surrounding the electrical conductor,
an electrically insulating layer surrounding the inner semiconducting layer,
an outer semiconducting layer surrounding the electrically insulating layer,
wherein at least the electrically insulating layer is made of a thermoplastic polymer material comprising at least one copolymer of ethylene with at least one C₄-C₈ alpha-olefin comonomer, wherein:
   the at least one C₄-C₈ alpha-olefin comonomer is present in the copolymer in an amount of from 1 to 10 mol %, for example from 1.5 to 5 mol %;
   the copolymer has a density of from 0.880 g/cc to 0.930 g/cc, for example from 0.900 g/cc to 0.925 g/cc;
   the copolymer has a melting profile, determined by Differential Scanning calorimetry (DSC), which includes a melting peak, corresponding to the maximum melting temperature of the melting profile, which defines a melting enthalpy up to 50% of the overall melting enthalpy.

For the purpose of the present disclosure and of the claims that follow, except where otherwise indicated, all numbers expressing amounts, quantities, percentages, and so forth, are to be understood as being modified in all instances by the term “about”. Also, all ranges include any combination of the maximum and minimum points disclosed and include any intermediate ranges therein, which may or may not be specifically enumerated herein.

For the purpose of the present description and of the appended claims, the words “a” or “an” should be read to include one or at least one and the singular also includes the plural unless it is obvious that it is meant otherwise. This is done merely for convenience and to give a general sense of the disclosure.

For the purposes of the present disclosure and of the claims that follow the following terms are defined as follows:
“medium voltage” means a voltage of between 1 kV and 35 kV, whereas “high voltage” means voltages higher than 35 kV, for example up to 600 kV or more;
“electrically insulating layer” means a covering layer made of a material having insulating properties, namely having a dielectric rigidity (dielectric breakdown strength) of at least 5 kV/mm, for example of at least 10 kV/mm;
“semiconductive layer” means a covering layer made of a material having semiconductive properties, such as a polymeric matrix added with, e.g., carbon black, such as to have a volumetric resistivity value, at room temperature (25° C.), of less than 500 Ω·m;
   “thermoplastic polymer material” refers to a polymer material that is non-crosslinked.

The power cable of the present disclosure may be a medium voltage or a high voltage cable. The power cable comprises at least one electrical conductor, i.e. an electrically conducting element of elongated shape and made of a metallic material. The electrical conductor may be in the form of metal wires or rod. The electrical conductor can be made of aluminium, of aluminium alloy, of copper, of copper alloy and of one of their combinations.

In an embodiment, the cable comprises an insulating system wherein at least one, preferably both, of the inner and outer semiconductive layers comprises the thermoplastic polymer material of the electrically insulating layer, further including a conductive filler, for example a carbon black filler.

In an embodiment, the C₄-C₈ alpha-olefin comonomer is an olefin of formula CH₂═CH—R, in which R represents a linear or branched alkyl group containing from 2 to 6 carbon atoms. For example, the C₄-C₈ alpha-olefin comonomer is selected from 1-butene, isobutene, 1-pentene, 4-methyl-1-pentene, 1-hexene, 1-octene, or mixtures thereof. In one embodiment, the C₄-C₈ alpha-olefin comonomer is selected from 1-butene, 1-hexene, 1-octene, or mixtures thereof.

In an embodiment, the copolymer of ethylene with at least one C₄-C₈ alpha-olefin comonomer has a Vicat softening point, measured according to ASTM D1525-09 (2014), of at least 90° C., for example from 95° C. to 120° C.

In an embodiment, the copolymer of ethylene with at least one C₄-C₈ alpha-olefin comonomer has a maximum melting temperature, measured by DSC, equal to or greater than 100° C., though copolymers with lower melting temperature could be anyway suitable for certain applications. The melting temperature of the copolymer of ethylene can be up to 135° C.

In an embodiment, the copolymer of ethylene with at least one C₄-C₈ alpha-olefin comonomer of the present disclosure has a molecular weight distribution index Mz/Mn up to 20, for example from 5 to 19.8.

The molecular weight distribution index Mz/Mn may be measured by means of high-temperature size exclusion chromatography (HT-SEC).

In an embodiment, the copolymer of ethylene with at least one C₄-C₈ alpha-olefin comonomer of the present disclosure is a semicrystalline thermoplastic material which can be processed at temperatures higher than its melting temperature. A semicrystalline copolymer according to the present disclosure has a degree (a.k.a. percentage) of crystallinity (χ_{c}) of from 5 to 60%, for example from 20% to 50%.

The degree of crystallinity (χ_{c}) is calculated, e.g., by X-ray diffraction (XRD). The XRD patterns are processed to subtract the background and deconvoluted into crystalline and amorphous components using Gaussian functions for crystalline peaks, typically at 21.6° and 23.9°, and a broad halo for amorphous regions. Peak fitting and integration may be performed using OriginPro 2019.

The degree of crystallinity (χ_{c}) is calculated using the following formula:

$${χ}_{c} = \frac{{A}_{crystalline}}{{A}_{crystalline} + {A}_{amorphous}} \times 100$$

where A_{crystalline} is the integrated area under the crystalline peaks, and Aₐₘₒᵣₚₕₒᵤₛ is the area under the amorphous halo.

Copolymers of ethylene with at least one C₄-C₈ alpha-olefin comonomer according to the present disclosure may be included in the polyethylene classes known on the market as LLDPEs (Linear Low Density Polyethylenes) or VLDPEs (Very Low Density Polyethylenes). They can be produced according to or analogously to conventional polymerisation processes, which are well known in the art. In particular, they may be obtained by copolymerization of ethylene with at least one C₄-C₈ alpha-olefin comonomer at low pressure in the presence of a suitable catalyst. Suitable catalysts may be selected from: Ziegler-Natta catalysts, single site catalysts (including metallocene and non-metallocene single-site catalysts), chromium catalysts, or mixtures thereof. In an embodiment, the present ethylene copolymers are obtained by single site catalysis.

The thermoplastic polymer material according to the present disclosure may additionally comprise other conventional components, such as antioxidants, processing aids, water tree retardants, voltage stabilizers, or mixtures thereof.

Conventional antioxidants suitable for the purpose are for example: 4,6-bis (octylthiomethyl)-o-cresol, thio-diethylene bis[3-(3,5-di-tert-butyl-4-hydroxyphen-yl) propionate], distearyl- or dilauryl-thiopropionate, dioctadecy 1-3,3′-thiodipropion-ate, 2′,3-Bis[[3-[3,5-di-tert-butyl-4-hydroxyphenyl]-propionyl]]propionohydrazide, tris(2,4-di-tert.-butyl-phenyl)phosphite and pentaerythritol tetrakis[3-(3,5-di-t-but-yl-4-hydroxyphenyl) propionate], or mixtures thereof.

According to the present disclosure, the electrically insulating layer of the power cable is non-crosslinked and is obtained by extrusion.

The insulating system of the cable in accordance with the present disclosure may be obtained by conventional extrusion processes well known to a person skilled in the art.

For example, the layers of the insulating system may be prepared by extruding the thermoplastic polymer material, optionally in admixture with other additives, onto the electrical conductor by using extruding equipments, such as single-screw extruders, or co- or counter-rotating double-screw extruders. The extrusion of the semiconducting layer/s and of the electrically insulating layer can be carried out consecutively, for example using two or three separate extruders arranged in series, or simultaneously, for example by co-extrusion using a single extrusion head.

The electrically insulating layer has a thickness which can vary as a function of the type of cable to be produced.

As regards the semiconducting layers, these can be formed by a thermoplastic (i.e. non-crosslinked) polymer material, which can be that of the present disclosure, charged with at least one conductive filler, for example a carbon black filler. The conductive filler is generally dispersed within the polymeric material in a quantity such as to provide the material with semiconducting properties, for example to obtain a volumetric resistivity value, at room temperature (25° C.), of less than 500 Ω·m, fo example less than 20 Ω·m. The amount of carbon black may range from 1% to 50% by weight, for example from 3% to 30% by weight, relative to the weight of the polymer.

Typically, a metal, e.g. copper or aluminium, screen is placed around the insulating system according to well-known techniques. Other layers, such as water swelling layers, which swell in the presence of moisture, may be added, for example between the outer semiconducting layer and the metal screen.

The present disclosure, in at least one of the aforementioned aspects, may be implemented according to one or more of the present embodiments, optionally combined together.

### DETAILED DESCRIPTION OF THE PREFERRED EMBODIMENTS

Further characteristics will be apparent from the detailed description given hereinafter with reference to the accompanying drawings, in which:

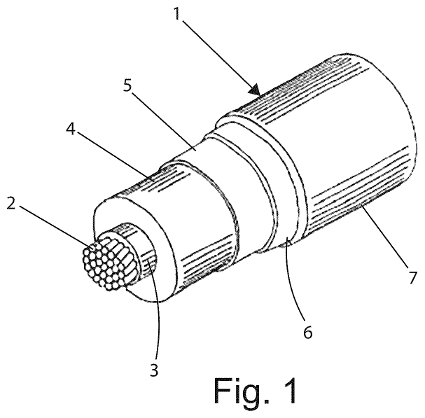

FIG. 1 is a perspective view of a power cable, particularly suitable for medium or high voltage, according to the present disclosure.

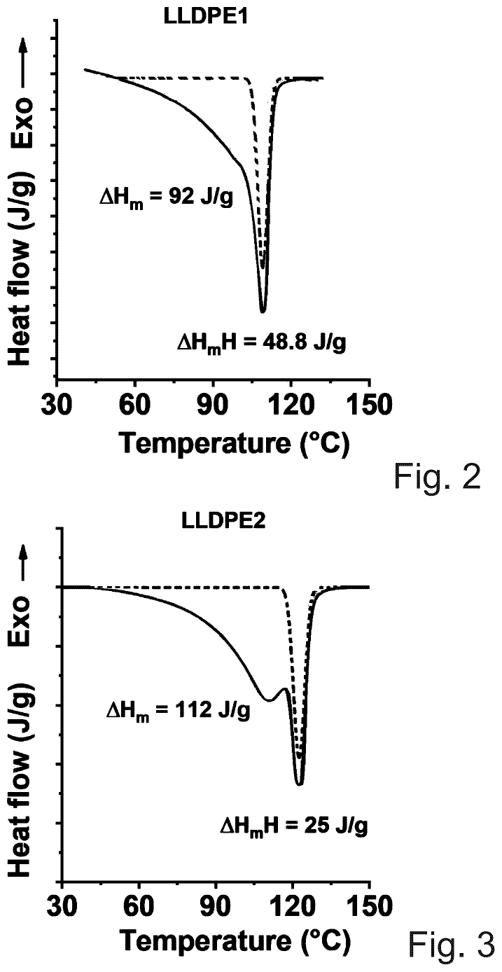

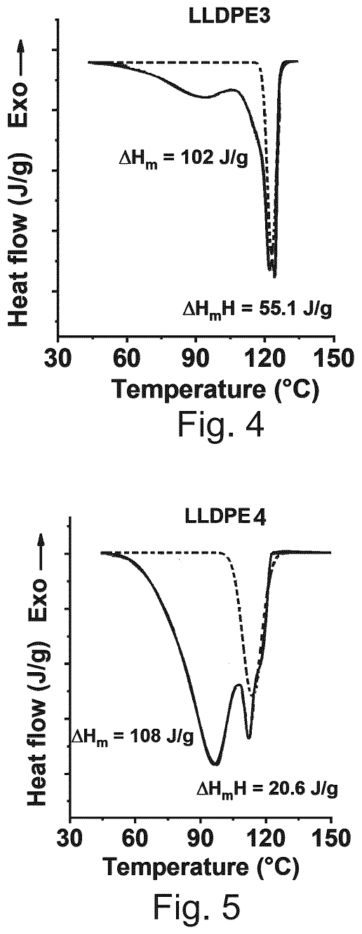

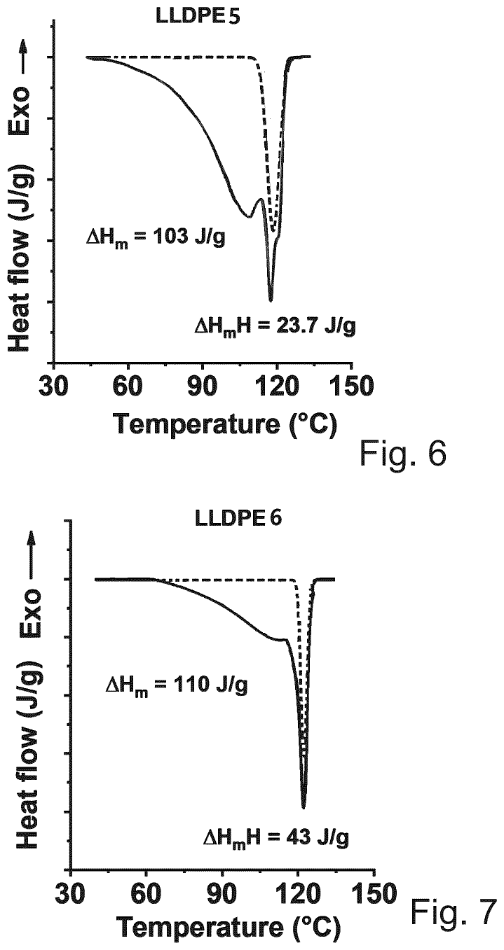

FIGS. 2-7 show the DSC curves and the deconvolution thereof of copolymers according to the present disclosure and comparative ones.

In FIG. 1, the power cable (1) comprises a conductor (2), an inner semiconducting layer (3), an electrically insulating layer (4), an outer semiconducting layer (5), a metal screen (6), and an outer sheath (7).

The conductor (2) generally consists of metal wires, for example of copper or aluminium, stranded together by conventional methods, or of a solid aluminium or copper rod. At least one of the inner semiconducting layer (3), the electrically insulating layer (4) and the outer semiconducting layer (5) comprises the thermoplastic polymer material of the present disclosure.

Around the outer semiconducting layer (5), the metal screen (6) is usually positioned, generally in the form of electrically conducting wires or strips wound helically. The metal screen (6) is then covered by the sheath (7) of a polymeric material such as, for example, high-density polyethylene (HDPE).

The power cable may be also provided with one or more protective structure (not shown in FIG. 1), the main purpose of which is to mechanically protect the cable against impacts, tensile stress and/or compressions, and/or which is a water barrier. This protective structure may be, for example, a metal reinforcement or a layer of expanded polymer as described in WO 98/52197, or an armour layer made of a metal or of a synthetic material as disclosed, e.g., in WO2018/059685

FIG. 1 shows only one possible embodiment of a power cable according to the disclosure. Suitable modifications known in the art may be made to this embodiment, but without departing from the scope of the disclosure.

The following examples are provided to further illustrate the present disclosure.

### EXAMPLES

Different ethylene copolymers (LLDPE) reported in Table 1 were used as thermoplastic polymers materials in form of pellet.

TABLE 1

| | | | Degree | | | |
|---|---|---|---|---|---|---|
| | | Den- | of | | MFI | |
| | Comon- | sity | crysta- | | (g/ | |
| | omer | (g/ | llinity | Vicat | 10 | Mz/ |
| Example | (mol %) | cm³) | (%) | (° C.) | min) | Mn |
| LLDPE | C₈ (2.56) | 0.9082 | 32 | 95 | 1 | 4.01 |
| 1 * | | | | | | |
| LLDPE | C₈ (1.85) | 0.9167 | 40 | 106 | 1 | 9.83 |
| 2 | | | | | | |
| LLDPE | C₈ (2.2) | 0.9173 | 41 | 104 | 0.85 | 6.33 |
| 3 * | | | | | | |
| LLDPE | C₆ (2.1) | 0.9076 | 32 | 90 | 2 | 19.63 |
| 4 | | | | | | |
| LLDPE | C₆ (1.75) | 0.9184 | 40 | 107 | 0.9 | 10.52 |
| 5 | | | | | | |
| LLDPE | C₄ (10) | 0.9186 | 38 | 96 | 2.5 | 8.33 |
| 6 | | | | | | |

* comparative
C₈: 1-octene;
C₆: 1-hexene;
C₄: 1-butene;
Density: measured according to ASTM D792-08;
Crystallinity: measured by XRD as referred above;
Vicat softening point: measured according to ASTM D1525-09;
MFI (Melt Flow Index): measured at 190° C./2.16 kg according to ASTM 1238-04.

The molecular weight distribution index Mz/Mn was measured by means of high-temperature size exclusion chromatography (HT-SEC). The following procedure was followed.

### 1. Sample Preparation:

The polymer in the form of pellets was subjected to cryogenic grinding by placing the pellets in a grinding jar with a stainless-steel ball, freezing in liquid nitrogen for 15 minutes, and milling for 7 minutes, repeated twice for each sample. The resulting powder was sieved to select particles of desired size. 10 mg of the final powder were weighed for subsequent analysis.

### 2. Sample Solubilization:

The powder sample obtained as above was added with an antioxidant, specifically butylated hydroxytoluene (BHT) at 0.05%, to prevent thermal degradation. The polymer powder was then dissolved in o-dichlorobenzene (o-DCB). The so obtained solution was incubated in an oven at 160° C. for one hour. The solution was then filtered using sintered metal filters with a 0.5 μm pore size. The so prepared solution was maintained in the injection compartment of the HT-SEC system at 135° C.

### 3. Chromatographic Analysis:

The sample was injected into an integrated HT-SEC system equipped with a differential refractometer (DRI) as a concentration detector. The column set was composed by HT-GPC/SEC columns (8.0 mm×300 mm) for chlorinated organic eluent and with cross-linked polystyrene/divinylbenzene (PS/DVB) beads as the stationary phase, resolving molecular weight distribution range 1000 Da to 10 MDa. The mobile phase was o-dichlorobenzene, with a flow rate of 0.8 mL/min, at a temperature of 135° C., and an injection volume of 220 μL. The mobile phase was degassed under vacuum. The sample concentration was set to 2 mg/mL.

### 4. System Calibration:

A third-order polynomial calibration curve was constructed using sixteen narrow MWD polystyrene standards, with peak molecular weights ranging from 3,280,000 g/mol to 162 g/mol. Such calibration curve was used to correlate elution volume with molecular weight.

### 5. Data Acquisition and Processing:

Chromatographic data were acquired and processed by using dedicated software (Empower Pro 1.0).

The mechanical properties of the LLDPEs of Table 1 were measured according to standard ASTM D790 (1991). The results are reported in Table 2.

TABLE 2

| Example | Flexural modulus (MPa) |
|---|---|
| LLDPE 1 * | 137 |
| LLDPE 2 | 403 |
| LLDPE 3 * | 340 |
| LLDPE 4 | 197 |
| LLDPE 5 | 323 |
| LLDPE 6 | 371 |

* comparative

The DSC profiles of the LLDPEs of Table 1 were measured according to ISO 11357-1 (1997) and ISO 11357-3 (2018) on plates 0.5 mm thick (2nd heating). The DSC curves are reported in FIGS. 2-7 as a solid line.

From the DSC curves of FIGS. 2-7 the following parameters were determined:
ΔHₘ (J/g): total melting enthalpy;
T_{mH} (° C.): maximum melting temperature of the DSC profile;
ΔH_{mH} (J/g): melting enthalpy of the melting peak corresponding to the maximum melting temperature;
ΔH_{mH}/ΔHₘ: melting ratio: % ratio between the melting enthalpy of the melting peak corresponding to the maximum melting temperature and the overall melting enthalpy; each deconvoluted curve providing this value is reported in FIGS. 2-7 as a dashed line.

The results are reported in Table 3.

TABLE 3

| | ΔHₘ | T_{mH} | ΔH_{mH} | ΔH_{mH}/ΔHₘ |
|---|---|---|---|---|
| Example | (J/g) | (°C) | (J/g) | (%) |
| LLDPE 1 * | 92 | 109.0 | 48.8 | 53.0 |
| LLDPE 2 | 112 | 123.0 | 25.0 | 22.3 |
| LLDPE 3 * | 102 | 124.5 | 55.1 | 54.0 |
| LLDPE 4 | 108 | 113.0 | 20.6 | 19.1 |
| LLDPE 5 | 103 | 116.0 | 23.7 | 23.0 |
| LLDPE 6 | 110 | 122.0 | 43.0 | 39.1 |

* comparative

The values of tan δ @ 50 Hz, measured at 70° C. and 90° C. according to IEC 62631-2-1, relative permittivity and dissipation factor, technical frequencies (0.1 Hz-10 MHz), AC Methods, of the LLDPEs were measured on the materials in the form of plates 1 mm thick, and the results are reported in Table 4. Tan Delta (tan δ) or tangent of the angle 8, also called Loss Angle or Dissipation Factor, is a method of testing cables to determine the resistance of the cable insulation. In an ideal cable, the angle would be nearly zero. An increase in the tan δ value indicates an increase in the dissipative current through the insulation.

Moreover, the thermal conductivity of the materials was measured on plates 4×1 mm thick at 90° C. as reported below, and the results are also included into Table 4.

TABLE 4

| | | | Thermal |
|---|---|---|---|
| | Tanδ @ 50 Hz | Tanδ @ 50 Hz | conductivity @90 °C |
| Example | @70 °C | @90 °C | (W/m · K) |
| LLDPE 1 * | 0.00794 | 0.0256 | 0.27 |
| LLDPE 2 | 0.0000969 | 0.00018 | 0.30 |
| LLDPE 3 * | 0.0272 | 0.114 | 0.31 |
| LLDPE 4 | 0.0000899 | 0.000878 | 0.25 |
| LLDPE 5 | 0.00127 | 0.00769 | 0.29 |
| LLDPE 6 | 0.000171 | 0.000224 | 0.31 |

* comparative

The thermoplastic materials according to the present disclosure, i.e. Examples 2, 4, 5 and 6, showed tan δ values remarkably lower than those of the comparative thermoplastic materials (Examples 1 and 3). Referring back to Table 3, it is noted that the thermoplastic materials of the present disclosure had a melting ratio lower than 50%, while in all the comparative thermoplastic materials such value was greater than 50%.

The thermoplastic material of Example 4 according to the disclosure had a thermal conductivity slightly lower than that of the other thermoplastic materials (comparative and not). Anyway, an insulating layer or system made of that material can nonetheless be used in cables having a relatively lower operating temperature (i.e. the maximum temperature reached by the conductor under continuous operation) and/or deployed in an environment having a low average temperature, for example lower than 40° C., or even 30° C.

1. A power cable (1) comprising at least one electrical conductor (2) and an electrically insulating system comprising:
an inner semiconducting layer (3) surrounding the electrical conductor (2),
an electrically insulating layer (4) surrounding the inner semiconducting layer (3),
an outer semiconducting layer (5) surrounding the electrically insulating layer (4),
wherein at least the electrically insulating layer (4) is made of a thermoplastic polymer material comprising at least one copolymer of ethylene with at least one C₄-C₈ alpha-olefin comonomer, wherein:
the at least one C₄-C₈ alpha-olefin comonomer is present in the copolymer in an amount of from 1 to 10 mol %;
the copolymer has a density of from 0.880 g/cc to 0.930 g/cc;
the copolymer has a melting profile, determined by Differential Scanning calorimetry (DSC), which includes a melting peak, corresponding to the maximum melting temperature of the melting profile, which defines a melting enthalpy equal to or lower than 50% of the overall melting enthalpy.

2. The power cable (1) according to claim 1, wherein the at least one C₄-C₈ alpha-olefin comonomer is present in the copolymer in an amount of from 1.5 to 5 mol %.

3. The power cable (1) according to claim 1, wherein the copolymer of ethylene has a density of from 0.900 g/cc to 0.925 g/cc.

4. The power cable (1) according to claim 1, wherein at least one of the inner semiconducting layer (3) and the outer semiconducting layer (5) comprises at least one copolymer of ethylene with at least one C₄-C₈ alpha-olefin comonomer as defined in claim 1.

5. The power cable (1) according to claim 1, wherein the copolymer of ethylene with at least one C₄-C₈ alpha-olefin comonomer has a Vicat softening point, measured according to ASTM D1525-09 (2014), of at least 90° C.

6. The power cable (1) according to claim 5, wherein the copolymer of ethylene with at least one C₄-C₈ alpha-olefin comonomer has a Vicat softening point, measured according to ASTM D1525-09 (2014), of from 95° C. to 120° C.

7. The power cable (1) according to claim 1, wherein the copolymer of ethylene with at least one C₄-C₈ alpha-olefin comonomer has a maximum melting temperature, measured by DSC, equal to or greater than 100° C.

8. The power cable (1) according to claim 1, wherein the copolymer of ethylene has a molecular weight distribution index Mz/Mn up to 20.

9. The power cable (1) according to claim 8, wherein the copolymer of ethylene has a molecular weight distribution index Mz/Mn of from 5 to 19.8.

10. The power cable (1) according to claim 1, wherein the copolymer of ethylene has a degree of crystallinity of from 5 to 60%.

11. The power cable (1) according to claim 1, wherein the copolymer of ethylene has a degree of crystallinity of from 20% to 50%.
